(19) United States
(12) Patent Application Publication
(10) Pub. No.: US 2008/0228659 A1
(43) Pub. Date: Sep. 18, 2008

(54) Methods and vehicles for funding retained obligations

(76) Inventors: Karey B. Dearden, Princeton Junction, NJ (US); Peter Densen, Tenafly, NJ (US)

Correspondence Address: Paul E. Schaafsma;NovusIP, LLC, Suite 221, 521 West Superior Street, Chicago, IL, 60610-3135, US

(21) Appl. No.: 11/724,867

(22) Filed: Mar. 16, 2007

(51) Int. Cl. G06Q 40/00

(52) U.S. Cl. 705/36 R

(57) ABSTRACT

A method and vehicle for funding retained obligations in accordance with the principles of the present invention comprises pooling of investments from investors in an investment vehicle. No single investor's assets will be traced in any manner, including for purposes of measuring or allocating gain or loss. The investors share any gain or loss in accordance with their interest in the investment vehicle. The investment vehicle invests its assets with a preference for commercial paper of one or more interest holders of the investors; provided, that there is no requirement that the investment vehicle must buy a specific amount of any interest holders' commercial paper, or buy any interest holders' commercial paper at any specific time and the investment vehicle will not guarantee that a specific amount of contribution in the investment vehicle will equal a specific investment in commercial paper of an interest holder. The holding of commercial paper of any single interest holder does not make up a significant portion of the total investment of the investment vehicle. In one preferred embodiment, the method and vehicle for finding retained obligations in accordance with the present invention is directed to an investment vehicle for captive insurance companies, where the investment vehicle preferably invests in the commercial paper of a policyholder or the ultimate parent and/or subsidiaries and/or affiliates of a captive insurance company.

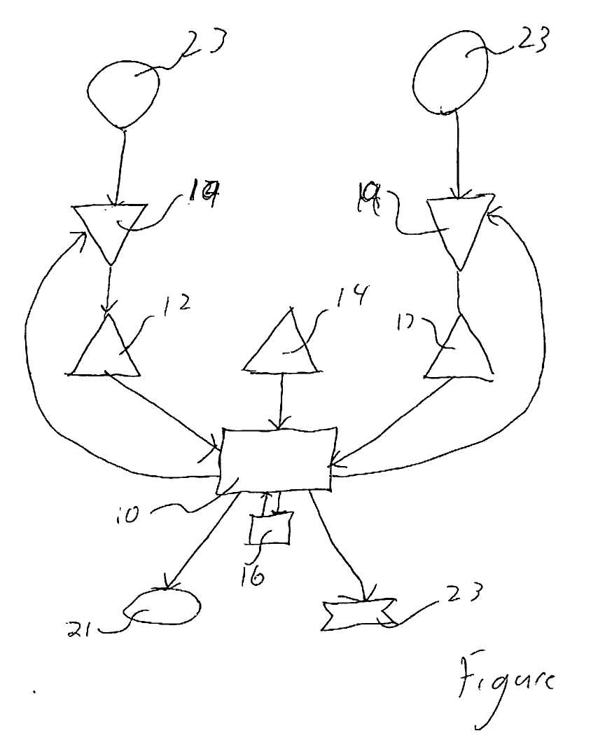

### FIELD OF THE INVENTION

The present invention relates to methods and vehicles for funding retained obligations.

### BACKGROUND OF THE INVENTION

Organizations have obligations, and each organization must determine how to fund its obligations. By obligations, what is meant is an incurred or contingent risk or contingent liability. An organization may transfer its obligations to third-parties, such as insurance companies, or retain such obligations. Retained obligations are obligations an organization has not transferred to a third-party. Such retained obligations can include, but are not limited to, self-insured retentions and obligations retained through certain insurance policies such as deductible policies, retrospectively rated insurance policies or finite insurance policies.

An organization can choose to fund its retained obligations using current earnings and/or current cash flow. Alternatively, an organization can fund its retained obligations by setting assets aside on its balance sheet; placing assets with insurance entities to satisfy collateral requirements for certain policy types; utilizing credit facilities; issuing additional equity; forming and utilizing formal funding vehicles such as a captive insurance company (captive); forming and utilizing other pension alternatives such as a trust created for the purpose of supporting the non-qualified benefit obligations of employers to their employees (Rabbi Trust); forming and utilizing other health and welfare funding alternatives such as a voluntary employee benefit association (VEBA) or forming and utilizing other types of obligation finding methods, systems or structures.

The use of a captive insurance company to fund the retained obligations of a company and its subsidiaries and affiliates is well known in the art. Such captive insurance companies are typically organized as direct or indirect wholly or partially owned subsidiaries of a parent company or companies, the parent company typically having one or more subsidiary companies, or as affiliates of the parent company, e.g., group or association type captives. A captive insurance company is generally capitalized by its direct or indirect parent or its shareholders and insures the risk of loss of the parent and/or its subsidiaries and sometimes unrelated risks. This structure provides certain advantages to the parent and its subsidiaries, such as for example a formalized vehicle to fund retained risk, access to reinsurance markets, price mitigation when placing certain lines of business, federal and state tax efficiencies, and enhanced loss control.

An organization that forms a type of entity such as a captive, a Rabbi Trust, a VEBA or other similar structure (herein non-limitedly referred to as a finding vehicle), must fund such funding vehicle. The funding vehicle generally cannot return the funds placed into the funding vehicle to the organization that created the funding vehicle, and the return on funds invested by the funding vehicle is usually less than the return would be if such assets had remained invested in the business of the organization that created the funding vehicle. Accordingly, an economic cost, e.g., a lost opportunity cost, may be created when an organization places funds into a funding vehicle.

For example, because of its status as an insurance company, both practical and regulatory considerations dictate that a captive insurance company invest in approved investments. Although typically very safe and liquid, these investments usually do not provide as high of a return as investments made in the business of the parent and/or subsidiaries and affiliates of the captive. Because the returns on investment to be gained through captive insurance companies are limited, some organizations are inclined to place their cash elsewhere—in investments that will provide a better return—rather than fund a captive insurance company. Thus, the benefits of using a captive insurance company have not been fully realized.

By tying cash up in a captive insurance company that achieves poorer results, the prior art approach to captive insurance companies deprives the companies forming such captives of cash that could be used to invest in better return investments. Although an organization can recover that cash through loans from the captive back to the organization, such loans may be seen as a mere circulation of funds by regulatory and/or taxing authorities and may nullify the economic and tax advantages of investing in a captive insurance company.

Because of the lost opportunity costs of utilizing a funding vehicle, organizations look for alternatives to such funding entities. One such alternative is for an organization to borrow money from third parties. Such borrowed funds are now in the business, and the earnings of the assets in a funding vehicle reduce the cost of such borrowed funds when viewed on a consolidated basis. The impediments to this strategy include the constant need to issue debt to reduce the lost opportunity cost, the constant need to reinvest the assets in the formal funding vehicle, the constant need to manage the difference between the interest on borrowed funds and the investment earnings on the assets in the funding vehicle, and whether debt is problematic given the capital management strategy of the organization.

Another such alternative to mitigate or eliminate this lost opportunity cost, if permissible, would be lending the assets of the funding vehicle to an entity within the same economic organization. Regulatory issues and/or U.S. federal income tax, and/or state and local tax considerations, however, generally limit the use of this strategy. Hence, the lost opportunity cost remains.

Thus, it would be desirable to fund retained obligations more efficiently. It would be desirable to fund retained obligations and at the same time allow an organization access to cash to invest in better performing investments. It would further be desirable to fund retained obligations in a method and vehicle to allow an organization to invest in better performing investments than those investments of a captive. It would further be desirable to fund retained obligations in a method and vehicle that combines the economic and tax advantages of a funding vehicle for retained obligations with better returns on cash investments of the funding entity than would ordinarily be provided, while providing enhanced risk control, access to reinsurance markets, a strategic tool to benefit stakeholders, a convenient cost of risk allocation vehicle for the organization, and combinations thereof. It would further be desirable to fund retained obligations in a method and vehicle that enables the diversification of investments within the investment method or vehicle to provide a better distribution of investment risk to allow investment risk to be mitigated. It would further be desirable to provide a new source for companies to sell commercial paper.

### SUMMARY OF THE INVENTION

A method and vehicle for funding retained obligations in accordance with the principles of the present invention funds retained obligations more efficiently. A method and vehicle for funding retained obligations in accordance with the principles of the present invention allows an interest holder access to cash to invest in better performing investments. A method and vehicle for funding retained obligations in accordance with the principles of the present invention allows an interest holder to invest in better performing investments than those investments of the funding vehicle. A method and vehicle for funding retained obligations in accordance with the principles of the present invention combines the economic and tax advantages of a funding vehicle for retained obligations with better returns on cash investments of the funding entity than would ordinarily be provided, while providing enhanced risk control, access to reinsurance markets, a strategic tool to benefit stakeholders, a convenient cost of risk allocation vehicle for the organization, and combinations thereof. A method and vehicle for funding retained obligations in accordance with the principles of the present invention enables the diversification of investments within the investment method or vehicle to provide a better distribution of investment risk to allow investment risk to be mitigated. A method and vehicle for funding retained obligations in accordance with the principles of the present invention provides a new source for companies to sell commercial paper.

A method and vehicle for funding retained obligations in accordance with the principles of the present invention comprises pooling of investments from at least two investors in an investment vehicle. No single investor's assets are traced in any manner, including for purposes of measuring or allocating gain or loss. The investors share gain or loss in accordance with their interest in the investment vehicle. The investment vehicle invests with a preference for commercial paper of one or more interest holders of the investors; provided, however, that there is no requirement that the investment vehicle must buy a specific amount of any interest holders' commercial paper, or buy any interest holders' commercial paper at any specific time, and the investment vehicle will not guarantee that a specific amount of contribution in the investment vehicle will equal a specific investment in commercial paper of an interest holder. The holding of commercial paper of any single interest holder does not make up a significant portion of the total investment of the investment vehicle. In one preferred embodiment, the method and vehicle for funding retained obligations in accordance with the present invention is directed to an investment vehicle for captive insurance companies, where the investment vehicle of the present invention preferably invests in the commercial paper of a policyholder or the ultimate parent and/or subsidiaries and affiliates of a policyholder.

### BRIEF DESCRIPTION OF THE DRAWING

The Figure is a schematic representation of an embodiment of a structure of the investment vehicle in accordance with the principles of the present invention.

### DETAILED DESCRIPTION OF THE INVENTION

In summary, a method and vehicle for funding retained obligations in accordance with the principles of the present invention comprises pooling of investments from at least two investors in an investment vehicle. No single investor's assets are traced in any manner, including for purposes of measuring or allocating gain or loss. The investors share gain or loss in accordance with their interest in the investment vehicle. The investment vehicle invests with a preference for financial instruments, which in a preferred embodiment is commercial paper, of one or more interest holders of the investors; provided, however, that there is no requirement that the investment vehicle must buy a specific amount of any interest holders' financial instruments, which in a preferred embodiment is an interest holder's commercial paper, or buy any interest holders' financial instruments, which in a preferred embodiment is an interest holder's commercial paper, at any specific time, and the investment vehicle will not guarantee that a specific amount of contribution in the investment vehicle will equal a specific investment in financial instruments, which in a preferred embodiment is an interest holder's commercial paper, of an interest holder. Any single interest holder's financial instruments, which in a preferred embodiment is an interest holder's commercial paper, should not make up more than some predetermined percentage of the total investment of the investment vehicle. In additional embodiments, the financial instruments, which in a preferred embodiment is an interest holder's commercial paper, is appropriately rated; the financial instruments, which in a preferred embodiment is an interest holder's commercial paper, is purchased on the same terms and conditions under which an unrelated third party can purchase the financial instruments, which in a preferred embodiment is commercial paper; and third parties also purchase the financial instruments, which in a preferred embodiment is commercial paper.

In one embodiment, the method and vehicle for funding retained obligations in accordance with the principles of the present invention is directed to an investment vehicle for captive insurance companies. No single policyholder or ultimate parent of a policyholder of the captive insurance companies' assets will be traced in any manner, including for purposes of measuring or allocating gain or loss. The investment vehicle invests its assets with a preference for commercial paper of one or more policyholders or the ultimate parent or subsidiaries or affiliates of a policyholder of the captive insurance companies; provided, that there is no requirement that the investment vehicle must buy a specific amount of the commercial paper of any policyholder or the ultimate parent or subsidiaries or affiliates of a policyholder of the captive insurance companies, or buy any commercial paper of any policyholder or the ultimate parent or subsidiaries or affiliates of a policyholder of the captive insurance companies at any specific time, and the investment vehicle will not guarantee that a specific amount of contribution in the investment vehicle will equal a specific investment in commercial paper of any policyholder or the ultimate parent or subsidiaries or affiliates of a policyholder of the captive insurance companies. Although descriptions herein refer to parent companies of the captive, the invention is not limited to the ultimate parent of the captive, but may also be utilized with subsidiaries and affiliates of the ultimate parent or other subsidiaries and affiliates which may function as one or more parents or affiliates of the captive. In addition, the ultimate parent or other subsidiaries or affiliates may function as one or more parents of the captive, and all should be understood to be within the scope of the term “parent”. The parent of the captive may be an individual or any other form of legal entity.

In more detail, in the method for funding retained obligations in accordance with the principles of the present invention, an investment vehicle is formed. The investment vehicle is preferably formed in a tax efficient manner. In one embodiment, the investment vehicle can be formed as a limited liability company or as a partnership such that it is treated as a flow-through entity for tax purposes. Investments from at least two investors are pooled in the investment vehicle for reinvestment by the investment vehicle. Investment into the investment vehicle may occur through direct investment, or through indirect means, such as for example by investment through a trust, partnership or other corporate entity such as, but not limited to, an insurance company.

In different embodiments, for example, the investment vehicle can include at least two independent captives investing in an investment vehicle; at least two independent trusts providing collateral for investors investing in an investment vehicle; at least two independent pension, deferred compensation, welfare benefit alternatives or other similar type plan investors investing in an investment vehicle; at least two independent insurance company investors investing in an investment vehicle; and combinations thereof.

The present invention is characterized in that the investment vehicle preferably invests in commercial paper of interest holders of the investors. Such interest holders can include, for example, direct or indirect parents of the investor, affiliates of the investor, direct or indirect subsidiaries of the direct or indirect parent of the investor, beneficiaries of the investor, direct or indirect insureds of the investor or any other type of entity or mechanism that has a direct or indirect interest in the investor. In one embodiment, at least two investors invest in a holding entity which has ownership of at least one investment vehicle. The investors' funds placed in the holding entity are then placed by the holding entity into one or more investment vehicles owned by the holding entity that in turn invest in commercial paper of interest holders of the investors.

Investors make this investment so the interest holders of the investors can gain the advantages of the method and vehicle for funding retained obligations in accordance with the principles of the present invention. Even if an organization is not interested in utilizing the advantages of this structure for funding obligations, an option for an investor is available who desires to earn the investment returns and participate in the other advantages of the investment vehicle such as superior investment diversification and liquidity.

The investors in the investment vehicle of the present invention share any gain or loss in accordance with their interest in the investment vehicle, without regard to the source of the loss or gain. That is, performance of a particular commercial paper is not traced back to the particular investor from whose interest holder the commercial paper was issued for purposes of measuring or allocating gain or loss. The investors in the investment vehicle generally share any gain or loss on the investments in the investment vehicle in proportion to their ownership interests.

The number of investors is preferably sufficiently large in order to achieve a required investment distribution; further, the number of investors is preferably sufficiently small to avoid being considered a public offering. For example, in one embodiment, the number of captives and parents preferably is sufficiently large in order to achieve the investment distribution required while preferably avoiding so large a number that the investment vehicle is considered a public offering under the securities laws and regulations. One advantage of having a large number of investors in the investment vehicle is that the investments of the investment vehicle can be better diversified, and losses, if any, can be spread among more participants.

The investment vehicle invests its assets with a preference for commercial paper of one or more interest holders of the investors. Other than the preference to purchase commercial paper of interest holders of investors in the investment vehicle of the present invention, no requirement is made for the investment vehicle to purchase a specific amount of any commercial paper or to purchase commercial paper at any specific time. The investment vehicle does not guarantee that a contribution of a specific amount to the investment vehicle by an investor will result in the investment vehicle investing a like amount in the commercial paper of the interest holders of the investors in the investment vehicle. The commercial paper of any single interest holder should not make up more than some predetermined percentage of the total investment of the investment vehicle.

In additional embodiments, the commercial paper can achieve certain criteria. In order to ensure adequate diversification of the investment vehicle, the commercial paper can preferably be appropriately rated. This criterion ensures that the investment of the investment vehicle is not more risky than what it would otherwise be without the preference for the interest holders of the investors in the investment vehicle. The commercial paper can preferably be purchased on the same terms and conditions under which an unrelated third party can purchase the commercial paper. This criterion ensures that the investment vehicle is purchasing the commercial paper at an arm's length price and that the investment vehicle is seen to be in the business of trading commercial paper rather than in the financing business. Third parties should also preferably purchase the commercial paper, preferably in a substantial amount. This criterion ensures that a market exists for the commercial paper so that the investment is liquid.

Assuming the requisite criteria are met and that the investment is prudent, the investment vehicle purchases commercial paper from interest holders of the investors in the investment vehicle. The investment vehicle may also purchase other investments to combine with the commercial paper from interest holders of the investors in the investment vehicle of the present invention if, for example, the above criteria cannot be met or other prudent investments are available.

Referring now to the Figure, an example structure for funding retained obligations in accordance with the principles of the present invention is described. An investment vehicle 10 is provided. The investment vehicle can be a flow-through entity—such as a partnership or a limited liability company—for tax purposes. The investment vehicle 10 is funded. In one example of such funding, at least two independent investors 12 invest in the investment vehicle 10. In another embodiment, at least one independent investor 14 can also invest in the funding vehicle 10.

The funding provided by the investors 12, 14 is pooled in the investment vehicle 10 for investment. The investment vehicle 10 pools the investments of the investors 12, 14 in a single pool. The assets of the investors 12, 14 will not be traced in any manner, including for purposes of measuring or allocating gain or loss; thus, the investors 12, 14 in the investment vehicle 10 share any gain or loss in proportion to their ownership interests in the investment vehicle 10, without regard to the source of the loss or gain.

A managing member, general partner or other similar governing body can operate the investment vehicle 10. The governing body may act as, or choose, an investment manager 16 to invest the monies of the investment vehicle 10. The investment manager 16 will preferably have responsibility for determining how to invest the assets of the investment vehicle 10.

The investment vehicle 10 preferably invests in commercial paper of interest holders 19 of the investors 12. Thus, the investment manager 16 is directed to give preference to purchasing at least one type of commercial paper of the interest holders 19 of the investors in the investment vehicle 10; however, the investment manager 16 is not required to buy a specific amount of any commercial paper of the interest holders 19, or buy any commercial paper of the interest holders 19 at any specific time, and the investment manager 16 does not buy any commercial paper based on the investment of the interest holders 19. In addition, the investment manager 16 is also directed to invest such that commercial paper of any single interest holder does not make up a significant portion of the total investment of the investment vehicle 10.

In additional embodiments, the investment manager 16 may be made subject to additional investment criteria: the commercial paper is appropriately rated; the commercial paper are purchased on the same terms and conditions under which an unrelated third party 23 can purchase the commercial paper; and at least one third party 23 owns the same commercial paper. The investment manager 16 also has the option to purchase other investments from unrelated third-parties 21 to combine with the commercial paper from interest holders 19 of the investors 12 in the investment vehicle if, for example, the above criteria are not met or other prudent investments are available. Ultimately, how to invest the assets of the investment vehicle 10 is determined by the investment manager 16 exercising his discretion and fiduciary duty to the investment vehicle 10.

In one embodiment, the option available for the investment vehicle 10 to purchase other investments from unrelated third-parties 21 includes purchasing a hedge or hedges 23 from an unrelated counter party. In one embodiment, the option available for the investment vehicle 10 to purchase other investments from unrelated third-parties 21 includes purchasing an option or options for a hedge or hedges from an unrelated counter party.

Thus, continuing the embodiment of a captive insurance company, an entity funds the captive insurance company. The captive insurance company insures the property and casualty risks of the finding entity. The funding entity pays arm's length premiums to the captive for the insurance. The funding entity transfers sufficient independent, uncorrelated risks to the captive so that risk distribution is present. The captive qualifies as an insurance company, and the arrangement between captive and the funding entity qualifies as insurance for federal income tax purposes.

The captive invests assets in an investment vehicle. The investment vehicle pools the investments of the captive and at least one additional investor in a single pool. The assets of the investors will not be traced in any manner, including for purposes of measuring or allocating gain or loss; thus, the investors in the investment vehicle share any gain or loss in proportion to their ownership interests in the investment vehicle, without regard to the source of the loss or gain. The investment criteria operate such that the investment vehicle has a preference to purchase commercial paper of an interest holder; provided, however, the investment vehicle does not buy a specific amount of commercial paper of an interest holder, or buy commercial paper of an interest holder at any specific time, and the investment vehicle does not buy commercial paper of an interest holder based on the investment of an investor. This embodiment is advantageous for a number of reasons. Sufficiently large companies (that is, the type that will find it advantageous and have the means to own a captive insurance company) regularly issue a variety of commercial paper in the public markets. The variety of commercial paper availability allows for a variety of fund types.

In another embodiment, instead of or in addition to the captive insurance company insuring the funding entity, the captive insurance company insures the property and casualty risks of subsidiaries and/or affiliates of the funding entity. The subsidiaries and affiliates of the funding entity pay arm's length premiums to the captive for their insurance. The subsidiaries and affiliates of the funding entity transfer sufficient independent, uncorrelated risks to the captive so that a risk distribution is present. The captive qualifies as an insurance company, and the arrangement between the captive and the subsidiaries and affiliates of the funding entity qualifies as insurance for federal income tax purposes. The captive invests assets in the investment vehicle.

By buying commercial paper of the interest holders or subsidiaries and affiliates of the interest holders, the interest holders receive cash that has been invested in the captive from the collective pool of funds provided by the captive insurance companies in the investment vehicle. That cash may then be used for any purpose—cash is a valuable commodity that can be saved, spent or preferably invested in investments that will provide a better rate of return than can be achieved by captive insurance companies.

In one embodiment, the investment vehicle of the captive insurance company can preferably invest in highly rated commercial paper. Highly rated in this context means A1/PI rated instruments, or similar grade of debt as rated by a generally accepted commercial rating agency such as Standard & Poor's, 55 Water Street, New York, N.Y. 10041 (“S&P”), Moody's Investors Service, Inc., 99 Church Street, New York, N.Y. 10007 (“Moody's”) or some other comparable credit rating agency, for example. By limiting investments to highly rated commercial paper, a captive insurance company can invest conservatively to protect its assets.

Importantly, a method and vehicle for funding retained obligations created in accordance with the principles of the present invention should be acceptable under the applicable statutes and regulations of the United States which are administered by the Internal Revenue Service. In summary, an investment vehicle of the present invention should be considered to have a business purpose and should be considered done not entirely to reduce taxes. In addition, an investment vehicle of the present invention should not be disregarded. An investment vehicle of the present invention should not be considered a “conduit” and should not be considered a “circular flow of cash” from the interest holder to the investor to the investment vehicle of the present invention and back to the interest holder.

In more detail, in one embodiment an investment vehicle of the present invention for captive insurance companies should be considered to have a business purpose and should be considered done not entirely to reduce taxes. An investment vehicle of the present invention should be considered a genuine multiple-party transaction “encouraged by a business or regulatory realities” for several reasons. Initially, the investors share the risk of loss of the commercial paper of the interest holders purchased by the investment vehicle. In addition, should the investor be organized in Bermuda, the investors' regulators would more likely approve treating an investment in the investment vehicle as a “relevant asset” for liquidity ratio purposes than they would a similarly sized investment in the commercial paper of the interest holders, but should not need regulatory approval for an investment in the investment vehicle of the present invention. Investors organized in other jurisdictions should have fewer insurance regulatory issues with regard to investing in the investment vehicle of the present invention than they would have if they made direct purchases of their interest holder's commercial paper. For accounting purposes, the interest holders do not offset their issuance of commercial paper with their investments in their investor or their investor's investment in the investment vehicle of the present invention. Thus, the transaction should not be deemed shaped solely by tax avoidance features with “meaningless labels” attached.

In the embodiment of an investment vehicle of the present invention for captive insurance companies, the investors need to invest their capital and surplus in a way which is safe and highly liquid so they can obtain cash to pay claims. Investing in the investment vehicle of the present invention meets that need, by providing a professionally managed and diversified pool of investment that is liquid. The choice of the investment vehicle of the present invention over other investments is like the choice of between two investment alternatives. There are several ways to satisfy the business need of the investors to invest, and the choice of the investment vehicle of the present invention is one permissible choice that provides the advantages described herein.

In addition, an investment vehicle of the present invention for captive insurance companies should not be disregarded, and so each investor should not be considered as purchasing its interest holder's own commercial paper and the true insurance transaction should not be undermined. While it may be unlikely that the investment vehicle of the present invention will suffer a loss on any interest holder's highly rated commercial paper, the law presumes that the interest holders and the other investors will follow their contractual and fiduciary obligation to the investor whose interest holder caused the loss and the investors will share in that loss proportionately.

The cash should not be deemed to flow from the interest holder to the investor to the investment vehicle of the present invention and back to the interest holder. The cash flows from the investors to the investment vehicle of the present invention—an independent third party—and then to the various interest holders based on specified investment criteria. There is no transaction between an investor and its interest holder. The investor does not buy commercial paper of its interest holder. The investment vehicle of the present invention—an independent third party—pools the contributions from the investors into a single pool to buy the commercial paper of the interest holders. Any of the investment vehicle's losses will be spread among the investors. The investment vehicle of the present invention does not trace invested assets of a single investor. Since interest holders will issue commercial paper at different times, the interest cost paid by interest holders will differ, but each investor will receive a share of investment vehicle gain that may be different from the interest paid by its interest holder. The important difference based on the partnership or LLC agreement and the web of fiduciary duties between the manager and the investors as partners makes the investment vehicle of the present invention have substance and breaks any circularity in the transaction.

In addition, an investment vehicle of the present invention for captive insurance companies should not be considered a “conduit” and should not be considered a “circular flow of cash” from the interest holder to the investor to the investment vehicle of the present invention and back to the interest holder, such that insurance premium are deemed not paid. Not only is the investment vehicle of the present invention managed as a viable concern to make a profit, but also the investment vehicle of the present invention actually spreads among the investment vehicle investors the risks that an investor in commercial paper of an interest holder will suffer a loss on that investment. The shifting of gains and losses on the commercial paper investments in the investment vehicle of the present invention is both real and permanent.

In addition, the cash flow should not be deemed circular because it has economic substance. The capital contributions from an interest holder to the investor put assets of the interest holder at risk. The investments from the investor to the investment vehicle of the present invention for the investment vehicle to purchase commercial paper issued by the interest holders shifts among the investors of the investment vehicle the risk of gain or loss on the commercial paper of an interest holder. These economical real risks make an investment vehicle of the present invention other than a meaningless circular flow of cash.

Still further, an investment vehicle of the present invention should not violate the U.S. Treasury department's partnership anti-abuse rules. The investors are not using the investment vehicle of the present invention to reduce the present value of their aggregate tax liabilities. Indeed, the investors could have directly purchased a diverse pool of commercial paper as an investment of their capital and reserves. Using an entity considered as a partnership for this purpose does not lower the tax liability of any partner. The investment vehicle partnership is bona fide since it is formed for the business purpose of providing the investors with an efficient means of investing in a diversified pool of commercial paper. In addition, the investors in the investment vehicle share any gains or losses proportionately.

As known in the art, methods for funding retained obligations in accordance with the principals of the present invention can be preferably embodied as a system cooperating with computer hardware components, and as a computer-implemented method on a machine readable medium.

The following are non-limiting examples demonstrating implementation of methods and vehicles for funding retained obligations in accordance with the principles of the present invention.

### EXAMPLE 1

As previously described, the invention presented herein is particularly suited for an investment vehicle having at least two captive insurance company investors, each having a direct or indirect parent, wherein the investment vehicle of the present invention preferentially invests in the commercial paper of the parent.

For purpose of explanation and illustration, and not limitation, an exemplary embodiment of an investment method and vehicle for funding retained obligations in accordance with the invention is described. In this example, the investment method and vehicle for funding retained obligations occurs through investment by at least two captive insurance companies. The captive insurance companies are regulated by either the Insurance Department of the State of Vermont; by the Bermuda Monetary Authority, a department of the government of Bermuda; or by the insurance regulatory authorities of its home state or country. If a captive is organized in Bermuda or in some foreign jurisdiction, the captive can make an election under Internal Revenue Code Section 953(d) to be taxed as a domestic corporation. Each captive is adequately capitalized for the risks it insures. No entity indemnifies, guarantees or props-up the captives.

Each captive insurance company has a funding entity who capitalizes and owns the captive insurance company. Thus, in this example the interest holder is the funding entity. Typically, the captive insurance company insures the property and casualty risks of the funding entity, the funding entity's subsidiaries and/or the funding entity's affiliates. The insureds pay arm's length premiums to the captive for their insurance. The insureds transfer sufficient independent, uncorrelated risks to the captive so that risk distribution is present. The captive qualifies as an insurance company, and the arrangement between captive and the insureds qualifies as insurance for federal income tax purposes.

The captive invests assets in an investment vehicle. The investment vehicle pools the investments of the captives in a single pool. The assets of the captives will not be traced in any manner, including for purposes of measuring or allocating gain or loss; thus, the captives share any gain or loss in proportion to their ownership interests in the investment vehicle, without regard to the source of the loss or gain. The investment operates such that the investment vehicle has a preference to purchase commercial paper of a funding entity of one of the captive investors; provided, however, the investment vehicle does not buy a specific amount of commercial paper of a finding entity of one of the captive owners, or buy commercial paper of a funding entity one of the captive owners at any specific time, and the investment vehicle does not buy commercial paper based on the investment of a funding entity of one of the captive investors.

In this example, to be sufficiently large in order to achieve the investment distribution required the number of captives as funding entities is at least 10 while to avoid so large a number that the investment vehicle of the present invention is considered a public offering under the securities laws and regulations, 500 captives as funding entities is chosen. In addition, so that the applicable debt instrument does not make up a significant portion of the total investment of the investment vehicle, in this example no captive investor owns more than fifteen percent (15%) of the investment vehicle.

The captive desires to invest its assets supporting its capital and reserves in a safe and liquid market. The captive needs a liquid investment so that it can sell its investments easily to obtain cash to pay claims as claims payments become due. The captive has determined that an investment in a diversified pool of commercial paper is an appropriate type of investment for it to make. The captive will invest all, or substantially all, of its assets in an investment vehicle that qualifies as a domestic limited partnership for U.S. tax purposes. The investment vehicle will invest in the highly liquid commercial paper market. Investors in the investment vehicle will be permitted to enter, exit, increase or decrease their investment in the investment vehicle on a periodic basis. If required to provide some assurance to the initial investors at the time of the startup that the investment vehicle will have a certain number of investors, during an initial period of operation investors may not be permitted to liquidate their entire position in the investment vehicle.

A general partner owns an interest in the investment vehicle, such as for example a $50,000 interest. An investment manager is appointed by the general partner of the investment vehicle. The investment manager will manage the investments of the assets of the investment vehicle so as to maximize return on investment and to preserve capital, and will have a fiduciary obligation to the limited partners to manage the assets of the investment vehicle in accordance with these goals. The investment manager will receive a fee for its services.

As previously described, the investment vehicle directs the investment manager to give preference to purchasing commercial paper issued by the funding entity of each captive. In addition, in this example the investment vehicle directs the investment manager to fulfill the following criteria:
The commercial paper of the applicable funding entity is highly rated.
The investment vehicle purchases the commercial paper of the applicable funding entity on the same terms and conditions that such commercial paper is available to one or more third parties.
One or more third parties purchases the same commercial paper purchased by the investment vehicle.
   The investment manager determines in his or her sole discretion, that the purchase of a finding entity's commercial paper is, without regard to the rating of the commercial paper, a prudent investment for the investment vehicle of the present invention.

In this example, the commercial paper of the relevant funding entity remains rated A1/P1; the investment vehicle purchases the commercial paper of the funding entity on the same terms and conditions that any unrelated party purchases the commercial paper of the funding entity in the general commercial paper market; and unrelated investors purchase a substantial amount of the same issues of commercial paper of the funding entity which the investment vehicle purchases. Other than the preference for commercial paper of the funding entity subject to these conditions, there is no agreement that the investment vehicle will buy a specific amount of any funding entity's commercial paper, or buy any funding entity's commercial paper at any specific time. The investment vehicle does not guarantee that a contribution of a specific amount to the investment vehicle by a captive will result in the investment vehicle investing a like amount in commercial paper of the funding entity of that captive.

The assets within the investment vehicle are pooled for the collective benefit of the investors, and the investment vehicle does not trace its contribution to its investments for any purposes, including for purposes of measuring or allocating gain or loss. Any gain or loss will be shared among the investors of the investment vehicle in accordance with their interests in the investment vehicle in proportion to the balances in their capital accounts. No single investor's invested assets will be traced for purposes of measuring or allocating gain or loss. If there is a gain or a loss realized on any investment made by the investment vehicle, whether the commercial paper is issued by a funding entity of a captive or by a party with no connection to the investment vehicle, that gain or loss will be shared by investors in the investment vehicle in proportion to their ownership interests.

The liability of a funding entity for commercial paper issued should not be offset against the investment of the funding entity in a captive in the financial statements of the finding entity, nor should the liability of a funding entity for commercial paper issued be offset against the investment of the captive in the investment vehicle in the consolidated financial statements of funding entity and its captive. Neither a funding entity nor a captive should be consolidated with the investment vehicle for financial reporting purposes.

If a captive organized in Bermuda purchases commercial paper issued by its funding entity, the commercial paper of the funding entity should not be a “relevant asset” for Bermuda regulatory purposes unless the captive receives approval from its Bermuda insurance regulators. Bermuda insurance companies must maintain a “liquidity ratio” of “relevant assets” to “relevant liabilities” of at least seventy five percent (75%). Similarly, because the investment of the captive in the investment vehicle is not a quoted investment, the captive may not treat its investment in the investment vehicle as a relevant asset unless the captive receives approval of its Bermuda insurance regulators. Because the investment vehicle provides a much more diversified, and thus less risky investment, it should be easier for the captive to receive permission to treat an investment in the investment vehicle as a “relevant asset” than would be the case for an investment solely in commercial paper of the funding entity. Therefore, by investing in the investment vehicle rather than in commercial paper of the funding entity, the captive should more easily be able to treat its investment as a “relevant asset” and increase its liquidity ratio.

If a captive organized in Vermont purchases commercial paper issued by its funding entity, the purchase would have to be approved in advance by the Vermont regulators; however, if a Vermont captive purchases an interest in the investment vehicle, no advance regulatory approval should be necessary. Captives organized in other jurisdictions may have fewer insurance regulatory issues with regard to investing in the investment vehicle than they would have making direct investments in the commercial paper of their funding entity.

### EXAMPLE 2

For purpose of explanation and illustration, and not limitation, another exemplary embodiment of the system is described. In this example, the investment vehicle is similar to the exemplary embodiment of the investment vehicle of the Example 1 except that the captive forms and places funds in a trust that invests its assets in the investment vehicle. The captive has an interest in the trust. The trust is used to provide collateral for insurance companies reinsuring insurance business into a captive. This structure is advantageous because the cost of the collateral trust arrangement is generally lower than the cost of debt or of securing a funded letter of credit to provide such collateral.

### EXAMPLE 3

For purpose of explanation and illustration, and not limitation, another exemplary embodiment of the present invention is described. In this example, the investment vehicle is similar to the exemplary embodiment of the investment vehicle of the Example 1 except that the funding entity purchases a policy from a commercial insurer that requires a collateral fund be maintained within the insurance company to cover the insured's deductible. The commercial insurer invests the collateral fund in the investment vehicle, thus providing the funding entity access to the fungible pool of funds within the investment vehicle. The structure enables the funding entity to provide the collateral to the commercial insurance company at less cost, thereby increasing the available collateral that an insurance company has or mitigating the financial burden of providing collateral to commercial insurance companies.

### EXAMPLE 4

For purpose of explanation and illustration, and not limitation, another exemplary embodiment of the present invention is described. In this example, the investment vehicle is similar to the exemplary embodiment of the investment vehicle of the Example 1 except that the funding entity forms a Rabbi Trust to cover deferred compensation arrangements or pension arrangements. The structure enables the funding entity to fund the obligations placed in Rabbi Trust or similar type vehicle more economically, thereby providing greater certainty to the respective employees that such obligations will actually be paid.

### EXAMPLE 5

For purpose of explanation and illustration, and not limitation, another exemplary embodiment of the present invention is described. In this example, the investment vehicle is similar to the exemplary embodiment of the investment vehicle of the Example 1 except that the funding entity forms a VEBA to fund a variety of benefits including life (death benefits), sickness, accident, other benefits related to the welfare of employees, their dependents or beneficiaries or to cover SFAS 106 risks or other employee benefit type arrangements. The VEBA invests directly in the investment vehicle or indirectly through a captive insurance company formed by the funding entity. Regarding SFAS 106 risks, the VEBA purchases a life insurance policy on the lives of certain employees of the funding entity from a commercial insurer. The commercial insurer can either invest in the investment vehicle directly or invest in a captive insurance company formed by the funding entity that invests in the investment vehicle, thus providing the funding entity access to the pool of funds within the investment vehicle. The structure allows a more efficient, less costly funding of the variety of benefits placed in a VEBA thereby providing a possibility for enhanced benefits to employees and their beneficiaries or to increase profitability in the funding entity.

Thus, a method and vehicle for finding retained obligations in accordance with the principles of the present invention funds retained obligations more efficiently. A method and vehicle for funding retained obligations in accordance with the principles of the present invention allows an interest holder access to cash to invest in better performing investments. A method and vehicle for funding retained obligations in accordance with the principles of the present invention returns cash to an interest holder to allow it to invest in better performing investments than those investments of the funding vehicle. A method and vehicle for funding retained obligations in accordance with the principles of the present invention combines the economic and tax advantages of a funding vehicle for retained obligations with better returns on cash investments of the ultimate funding entity than would ordinarily be provided, while providing enhanced risk control, access to reinsurance markets, a strategic tool to benefit stakeholders, a convenient cost of risk allocation vehicle for the company, and combinations thereof. A method and vehicle for funding retained obligations in accordance with the principles of the present invention enables the diversification of investments within the methods or vehicle to provide a better distribution of investment risk to allow investment risk to be mitigated. A method and vehicle for funding retained obligations in accordance with the principles of the present invention provides a new source for funding entities to sell commercial paper.

While the invention has been described with specific embodiments, other alternatives, modifications and variations will be apparent to those skilled in the art. For example, several investment vehicles can be formed; at least two investors can invest in the investment vehicle; the interest holders of the investors may vary; the types and varieties of financial hedges employed by the investment vehicle may vary; the unrelated investments purchased by the investment vehicle will also vary given the investment vehicles' governing documents; and a plurality of holding entity structures or methods are possible. Accordingly, it will be intended to include all such alternatives, modifications and variations set forth within the spirit and scope of the appended claims.

What is claimed is:

1. A method for funding retained obligations comprising:
pooling of investments from at least two investors;
establishing a preference for investing in commercial paper of an interest holder of an investor;
not tracing assets of an investor for purposes of measuring or allocating gain or loss; and
ensuring that the holding of commercial paper of any single interest holder does not make up a significant portion of the total investment of the investment vehicle.

2. The method for funding retained obligations of claim 1 further wherein pooling of investments from the investors comprises establishing at least one trust that is owned by at least one investor.

3. The method for funding retained obligations of claim 1 further wherein pooling of investments from at least two investors comprises establishing an entity that qualifies as a domestic limited partnership and is owned by the investors.

4. The method for funding retained obligations of claim 1 further including investing in commercial paper of an interest holder selected from a group comprising a policyholder of the investor, a direct or indirect parent of the investor, a subsidiary of the investor, a subsidiary or affiliate of the direct or indirect parent, a trust formed by the investor, affiliates of the investor, and combinations thereof.

5. The method for funding retained obligations of claim 1 further including funding the investment vehicle by investment from a captive insurance company.

6. The method for funding retained obligations of claim 5 further including investing with a preference for commercial paper of an interest holder of a captive insurance company.

7. The method for funding retained obligations of claim 5 further including a parent of the captive insurance company capitalizing and owning the captive insurance company.

8. The method for funding retained obligations of claim 5 further including the captive insurance company insuring the property and casualty risks of the interest holder.

9. The method for funding retained obligations of claim 5 further including the captive insurance company insuring the property and casualty risks of subsidiaries or affiliates or both of the interest holder.

10. The method for funding retained obligations of claim 5 further including paying arm's length premiums to the captive insurance company for insurance.

11. The method for funding retained obligations of claim 5 further including the interest holder transferring sufficient independent, uncorrelated risks to the captive insurance company so that a risk distribution is present.

12. The method for funding retained obligations of claim 5 further including not offsetting a liability of an interest holder for commercial paper issued against an investment of the interest holder in a captive insurance company in the financial statements of the interest holder.

13. The method for funding retained obligations of claim 5 further including neither the interest holder nor the investment vehicle consolidating for financial reporting purposes.

14. The method for funding retained obligations of claim 5 further including a parent of the captive insurance company forming both a captive insurance company and a subsidiary or subsidiaries.

15. The method for funding retained obligations of claim 5 further including an interest holder of the captive insurance company purchasing a policy of insurance from a commercial insurer and the commercial insurer investing in the investment vehicle.

16. The method for funding retained obligations of claim 1 further including not offsetting a liability of the interest holder for commercial paper issued against an investment of the interest holder in a captive insurance company in the financial statements of the interest holder.

17. The method for funding retained obligations of claim 1 further including not offsetting a liability of the interest holder for commercial paper issued against an investment of the captive insurance company in the investment vehicle in the financial statements of the interest holder.

18. The method for finding retained obligations of claim 1 further including ensuring that the investment of the investment vehicle is not more risky than what it would otherwise be without the preference for the interest holders of the investors in the investment vehicle.

19. The method for finding retained obligations of claim 18 further including investing in appropriately rated commercial paper.

20. The method for finding retained obligations of claim 1 further including ensuring that the investment vehicle is purchasing commercial paper at an arm's length price and that the investment vehicle is seen to be in the business of trading commercial paper rather than in the financing business.

21. The method for funding retained obligations of claim 20 further including investing in commercial paper of an interest holder on the same terms and conditions under which an unrelated third party can invest in the commercial paper.

22. The method for funding retained obligations of claim 1 further including ensuring that a market exists for the commercial paper so that the investment is liquid.

23. The method for funding retained obligations of claim 22 further including investing in commercial paper of an interest holder in which at least one third party has also invested.

24. The method for funding retained obligations of claim 1 further including investing in commercial paper of an entity unrelated to the investors.

25. The method for funding retained obligations of claim 1 further including investing in an entity that invests in commercial paper of an interest holder of the investors.

26. The method for funding retained obligations of claim 1 further including purchasing a financial hedge.

27. The method for funding retained obligations of claim 26 further including purchasing an option to purchase a financial hedge.

28. The method for funding retained obligations of claim 1 further including pooling of investments from a number of investors that is sufficiently large in order to achieve a required investment distribution.

29. The method for funding retained obligations of claim 28 further including pooling of investments from at least ten investors.

30. The method for funding retained obligations of claim 1 further including pooling of investments from a number of investors that sufficiently small such that the investment is not considered a public offering.

31. The method for funding retained obligations of claim 30 further including pooling of investments from at most 500 investors.

32. The method for funding retained obligations of claim 1 further including ensuring that the holding of commercial papers of any single interest holder does not make up more than some predetermined percentage of the total investment.

33. The method for funding retained obligations of claim 32 further including investing in commercial paper of an interest holder that is sufficiently small such that commercial paper of a single interest holder do not make up more than about fifteen percent (15%) of the total investment.

34. The method for funding retained obligations of claim 1 further including sharing any gain or loss among the investors, without regard to the source of the loss or gain.

35. The method for funding retained obligations of claim 34 further including sharing any gain or loss among the investors in accordance with the interests of the investor.

36. The method for funding retained obligations of claim 1 further including, after an initial period, allowing investors to change their investment on a periodic basis.

37. The method for funding retained obligations of claim 36 further including during an initial period of operation, not permitting investors to liquidate their entire position.

38. The method for funding retained obligations of claim 1 further including pooling of investments within a holding entity formed by at least one investor and the holding entity placing its assets into at least one investment vehicle.

39. A method for funding retained obligations comprising:
creating an investment vehicle;
funding the investment vehicle by investments from investors, the number of investors the being sufficiently large in order to achieve a required investment distribution while being sufficiently small to avoid being considered a public offering;
establishing a preference for investing in commercial paper of interest holders of investors;
not requiring that the investment vehicle buy a specific amount of commercial paper of interest holders;
not requiring that the investment vehicle buy commercial paper of interest holders at any specific time;
not requiring that the investment vehicle guarantee that a contribution in the investment vehicle will equal an investment in commercial paper of an interest holder;
not tracing assets of an investor for purposes of measuring or allocating gain or loss; and
ensuring adequate diversification within the investment vehicle.

40. The method for funding retained obligations of claim 39 further wherein creating an investment vehicle comprises establishing at least one trust that is owned by at least one investor.

41. The method for finding retained obligations of claim 39 further wherein creating an investment vehicle comprises establishing an entity that qualifies as a domestic limited partnership and is owned by the investors.

42. The method for funding retained obligations of claim 39 further including a preference for investing in commercial paper of an interest holder selected from a group comprising a policyholder of the investor, a direct or indirect parent of the investor, a subsidiary of the investor, a subsidiary or affiliate of the direct or indirect parent, a trust formed by the investor, an affiliate of the investor, and combinations thereof.

43. The method for funding retained obligations of claim 39 further including funding the investment vehicle by investment from a captive insurance company.

44. The method for funding retained obligations of claim 43 further including preference for investing in commercial paper of an interest holder of the captive insurance company.

45. The method for finding retained obligations of claim 43 further including a parent of the captive insurance company capitalizing and owning the captive insurance company.

46. The method for funding retained obligations of claim 43 further including the captive insurance company insuring the property and casualty risks of the interest holder.

47. The method for funding retained obligations of claim 43 further including the captive insurance company insuring the property and casualty risks of subsidiaries or affiliates or both of the interest holder.

48. The method for funding retained obligations of claim 43 further including paying arm's length premiums to the captive insurance company for insurance.

49. The method for funding retained obligations of claim 43 further including the interest holder transferring sufficient independent, uncorrelated risks to the captive insurance company so that a risk distribution is present.

50. The method for funding retained obligations of claim 43 further including not offsetting a liability of an interest holder for commercial paper issued against an investment of the interest holder in a captive insurance company in the financial statements of the interest holder.

51. The method for funding retained obligations of claim 43 further including neither the interest holder nor the investment vehicle consolidating for financial reporting purposes.

52. The method for funding retained obligations of claim 43 further including a parent of the captive insurance company forming both a captive insurance company and a subsidiary or subsidiaries.

53. The method for funding retained obligations of claim 43 further including an interest holder of the captive insurance company purchasing at least one policy of insurance from a commercial insurer and the commercial insurer investing in the investment vehicle.

54. The method for funding retained obligations of claim 39 further including not offsetting a liability of the interest holder for commercial paper issued against an investment of the interest holder in a captive insurance company in the financial statements of the interest holder.

55. The method for funding retained obligations of claim 39 further including not offsetting a liability of the interest holder for commercial paper issued against an investment of the captive insurance company in the investment vehicle in the financial statements of the interest holder.

56. The method for funding retained obligations of claim 39 further including ensuring that the investment of the investment vehicle is not more risky than what it would otherwise be without the preference for the interest holders of the investors in the investment vehicle.

57. The method for funding retained obligations of claim 56 further including investing in an appropriately rated commercial paper.

58. The method for funding retained obligations of claim 39 further including ensuring that the investment vehicle is purchasing the commercial paper at an arm's length price and that the investment vehicle is seen to be in the business of trading commercial paper rather than in the financing business.

59. The method for funding retained obligations of claim 58 further including investing in commercial paper of an interest holder on the same terms and conditions under which an unrelated third party can invest in the commercial paper.

60. The method for funding retained obligations of claim 39 further including ensuring that a market exists for the commercial paper so that the investment is liquid.

61. The method for funding retained obligations of claim 60 further including investing in commercial paper of an interest holder in which at least one third party has also invested.

62. The method for funding retained obligations of claim 39 further including investing in commercial paper of an entity unrelated to an investor.

63. The method for funding retained obligations of claim 39 further including investing in an entity that invests in commercial paper of an interest holder of the investors.

64. The method for funding retained obligations of claim 39 further including purchasing at least one financial hedge.

65. The method for funding retained obligations of claim 64 further including purchasing at least one option to purchase at least one financial hedge.

66. The method for funding retained obligations of claim 39 further including pooling the investments from investors

67. The method for funding retained obligations of claim 66 further including pooling of investments from a number of investors that is sufficiently large in order to achieve a required investment distribution.

68. The method for funding retained obligations of claim 67 further including pooling of investments from a number of investors that sufficiently small such that the investment is not considered a public offering.

69. The method for funding retained obligations of claim 39 further including ensuring the commercial paper of a single interest holder do not make up a significant portion of the total investment of the investment vehicle.

70. The method for funding retained obligations of claim 39 further including sharing any gain or loss among the investors, without regard to the source of the loss or gain.

71. The method for funding retained obligations of claim 70 further including sharing any gain or loss among the investors in accordance with the interests of the investor.

72. The method for funding retained obligations of claim 39 further including, after an initial period, allowing investors to change their investment on a periodic basis.

73. The method for funding retained obligations of claim 72 further including during an initial period of operation, not permitting investors to liquidate their entire position.

74. The method for funding retained obligations of claim 39 further including pooling of investments within a holding entity formed by at least one investor and the holding entity placing its assets into at least one investment vehicle.

75. A method for funding retained obligations comprising:
funding an investment vehicle by investment from at least two investors;
the investment vehicle having a preference for investing in commercial paper of an interest holder of an investor;
the investment vehicle not tracing assets of an investor for purposes of measuring or allocating gain or loss; and
the commercial paper further having criteria selected from the group comprising:
ensuring that the investment of the investment vehicle is not more risky than what it would otherwise be without the preference for the interest holders of the investors in the investment vehicle;
ensuring that the investment vehicle is purchasing the commercial paper at an arm's length price and that the investment vehicle is seen to be in the business of trading commercial paper rather than in the financing business;
ensuring that a market exists for the commercial paper so that the investment is liquid; and
combinations thereof.

76. The method for funding retained obligations of claim 75 further including ensuring that the holding of commercial paper of a single interest holder does not make up a significant portion of the total investment of the investment vehicle.

77. The method for funding retained obligations of claim 75 further wherein funding the investment vehicle by investment from investors comprises establishing at least one trust that is owned by at least one investor.

78. The method for finding retained obligations of claim 75 further wherein funding the investment vehicle by investment from investors comprises establishing an entity that qualifies as a domestic limited partnership and is owned by the investors.

79. The method for finding retained obligations of claim 75 further including investing in commercial paper of an interest holder selected from a group comprising a policyholder of the investor, a direct or indirect parent of the investor, a subsidiary of the investor, a subsidiary of the direct or indirect parent, a trust formed by the investor, affiliates of the investor, and combinations thereof.

80. The method for funding retained obligations of claim 75 further including funding the investment vehicle by investment from a captive insurance company.

81. The method for funding retained obligations of claim 75 further including ensuring that the investment of the investment vehicle is not more risky than what it would otherwise be without the preference for the interest holders of the investors in the investment vehicle by investing in an appropriately rated commercial paper.

82. The method for finding retained obligations of claim 75 further including ensuring that the investment vehicle is purchasing commercial paper at an arm's length price and that the investment vehicle is seen to be in the business of trading commercial paper rather than in the financing business by investing in commercial paper of an interest holder on the same terms and conditions under which an unrelated third party can invest in the commercial paper.

83. The method for funding retained obligations of claim 75 further including ensuring that a market exists for the commercial paper so that the investment is liquid by investing in commercial paper of an interest holder in which at least one third party has also invested in the issuance of such commercial paper.

84. The method for funding retained obligations of claim 75 further including investing in commercial paper of an entity unrelated to an investor.

85. The method for funding retained obligations of claim 75 further including purchasing at least one financial hedge.

86. The method for funding retained obligations of claim 85 further including purchasing at least one option to purchase at least one financial hedge.

87. The method for funding retained obligations of claim 75 further including pooling the investments from investors

88. The method for funding retained obligations of claim 75 further including funding the investment vehicle by investments from a number of investors that is sufficiently large in order to achieve a required investment distribution.

89. The method for funding retained obligations of claim 75 further including funding the investment vehicle by investments from a number of investors that sufficiently small such that the investment is not considered a public offering.

90. The method for funding retained obligations of claim 75 further including investing in commercial paper of an interest holder in an amount that is sufficiently small to ensure adequate diversification.

91. The method for funding retained obligations of claim 75 further including sharing any gain or loss among the investors, without regard to the source of the loss or gain.

92. The method for funding retained obligations of claim 75 further including, after an initial period, allowing investors to change their investment on a periodic basis.

93. The method for funding retained obligations of claim 75 further including pooling of investments within a holding entity formed by at least one investor and the holding entity placing its assets into at least one investment vehicle.

94. An investment vehicle comprising:
funds provided by investment from at least two investors;
a business purpose for the investment vehicle;
the investment vehicle not created entirely to reduce taxes;
the investment vehicle not disregarded;
the investment vehicle not a conduit;
cash flow of the investment vehicle not circular;
the investment vehicle not violating partnership anti-abuse rules; and
the investment vehicle having a preference for an investment in commercial paper of an interest holder of an investor.

95. The investment vehicle of claim 94 further comprising a pool of investments from the investors held in at least one trust that is owned by at least one investor.

96. The investment vehicle of claim 94 further comprising an entity that qualifies as a domestic limited partnership and is owned by the investors.

97. The investment vehicle of claim 94 further wherein the interest holder of an investor is selected from the group comprising a policyholder of the investor, a direct or indirect parent of the investor, a subsidiary of the investor, a subsidiary of the direct or indirect parent, a trust formed by the investor, affiliates of the investor, and combinations thereof.

98. The investment vehicle of claim 94 further wherein at least one investor comprises a captive insurance company.

99. The investment vehicle of claim 94 further wherein the funds are provided to the investment vehicle directly by an investor.

100. The investment vehicle of claim 94 further wherein the funds are provided to the investment vehicle indirectly by an investor.

101. The investment vehicle of claim 94 further wherein the investment vehicle having a preference for an investment in commercial paper of an interest holder of an investor.

102. The investment vehicle of claim 94 further wherein the commercial paper of an interest holder is appropriately rated and is purchased on the same terms and conditions under which an unrelated third party can purchase the commercial paper; and further wherein at least one third party has also purchased the commercial paper.

103. The investment vehicle of claim 94 further wherein the number of investors is sufficiently large in order to achieve a required investment distribution.

104. The investment vehicle of claim 94 further wherein the number of investors is sufficiently small such that the investment vehicle is not considered a public offering.

105. The investment vehicle of claim 94 further wherein a sufficiently small number of commercial paper of a single interest holder are purchased to ensure adequate diversification of the investment vehicle.

106. The investment vehicle of claim 94 further wherein the investments from investors are pooled.

107. The investment vehicle of claim 94 further wherein assets of the investment vehicle are held in a pool such that any gain or loss of the investment vehicle is shared among the investors, without regard to the source of the loss or gain.

108. The investment vehicle of claim 94 further wherein, after an initial period, investors are allowed to change their investment in the investment vehicle on a periodic basis.

109. The investment vehicle of claim 94 further including a holding entity formed by at least one investor into which the investments are pooled, with the assets of the holding entity placed into at least one investment vehicle.
